(19) United States
(12) Patent Application Publication
(10) Pub. No.: US 2010/0226740 A1
(43) Pub. Date: Sep. 9, 2010

(54) Shipping container handling

(76) Inventors: Erik L. Humble, Otis Orchards, WA (US); Charles W. Moles, Newman Lake, WA (US)

Correspondence Address: Gregory IPL, P.C., 306 North Pines Road, SPOKANE VALLEY, WA, 99206-5180, US

(21) Appl. No.: 12/381,068

(22) Filed: Mar. 6, 2009

(51) Int. Cl. B60P 1/64; G05G 11/00

(52) U.S. Cl. 414/458; 74/484 R

(57) ABSTRACT

An apparatus for use with a shipping container includes a substantially rigid chassis and a connecting mechanism adapted to selectively connect a bottom corner of the container to the chassis. The apparatus further includes a wheel adapted to support the chassis on a surface and an elevating mechanism adapted to provide selective adjustment in elevation of the wheel relative to the chassis.

### TECHNICAL FIELD

The technical field of the inventions relates to means of handling shipping containers, and in particular, means of handling inter-modal shipping containers.

### BACKGROUND OF THE INVENTION

Over the last several decades, the business of transporting and handling freight has seen an increased use of shipping containers, particularly with respect to international and intercontinental shipments. The use of shipping containers is generally believed to significantly reduce the cost of freight handling when using more than one mode of transportation. For example, a typical overseas shipping container might be initially loaded onto a truck, after which it is loaded onto an ocean-going freighter, from which it is then transferred to a railcar. Thus, a shipment within a container can be transported with relative ease via several different transportation modes. If a subsequent transportation mode is unavailable at a transfer point, the container can simply be held at the transfer point until the next mode is available, thus eliminating the need for warehousing of the freight.

Shipping containers are also known as inter-modal containers. Most modern inter-modal containers are configured in accordance with requirements set by the ISO (International Organization for Standardization). Such requirements include standardized container dimensions and corner fitting configuration. Corner fittings are used for securing containers to the transport vessel or vehicle on which the container is being carried. Corner fittings are also used for lifting the container when loading and/or offloading or transferring the container between transport modes.

Corner fittings are usually located at each of the eight corners of a typical ISO shipping container. Specifically, there are four upper or top corner fittings, with one being located on each of the four upper or top corners of a typical container. Likewise, there are four lower or bottom corner fittings, with one being located on each of the four lower or bottom corners of a typical container. Corner fittings typically resemble a rectilinear block having six flat surfaces. Each corner fitting is generally hollow and is typically provided with three apertures, with each aperture being located in a corresponding surface. Each surface having an aperture is adjacent and normal to each of the other two surfaces having apertures. In this manner, each aperture corresponds to each of the three walls or sides that form a corner of a container.

Each of the apertures in the corner fitting is generally oblong or oval-shaped. Each container lifting means and container transport means is usually provided with a plurality of oblong or oval-shaped lugs that are supported on a larger structure. To connect the container to the lifting or transport means, each lug is aligned with an aperture on a corresponding corner fitting. Usually, upper corner fittings are used for lifting containers with overhead cranes, while the lower corner fittings are usually used for securing container to trucks and trailers. To affect connection to the container, each lug is inserted into a corresponding aperture and then twisted or rotated roughly ninety degrees, or one-quarter of a turn. At this point, the lug is within the corner fitting and cannot be removed from the aperture unless the lug is again rotated so as to align with the aperture. In this manner, a container can be secured by way of a plurality of the associated corner fittings and corresponding lugs, which are secured to a transport means or to a lifting means. Specially configured lug apparatus can also be used to securely connect one container to another, such as when stacking containers on a freighter or on a railcar.

Three specific sizes of shipping containers are referred to, respectively, as BiCons, TriCons, and QuadCons. A BiCon is usually dimensioned so that two BiCons connected together form a footprint equivalent to a standard twenty-foot ISO container. Similarly, a TriCon is usually dimensioned so that three TriCons connected together form a footprint equivalent to a standard twenty-foot ISO container. Likewise, a QuadCon is usually dimensioned so that four QuadCons connected together form a footprint equivalent to a standard twenty-foot ISO container. TriCons, QuadCons, and sometimes BiCons have been employed in military field operations for various purposes.

### BRIEF DESCRIPTION OF THE DRAWINGS

Preferred forms, configurations, embodiments and/or diagrams relating to and helping to describe preferred versions of the inventions are explained and characterized herein, often with reference to the accompanying drawings. The drawings and all features shown therein also serve as part of the disclosure of the inventions of the current application whether described in text or merely by graphical disclosure alone. Such drawings are briefly described below.

FIG. 1 is an elevation view showing apparatus having aspects and features according to the inventions taught herein.

FIG. 2 is a plan view of the apparatus depicted in FIG. 1.

FIG. 3 is a detail elevation view showing apparatus depicted in FIG. 1.

FIG. 4 is plan view of the apparatus depicted in FIG. 3

FIG. 5 is a plan view showing additional apparatus according to the inventions taught herein.

### DETAILED DESCRIPTION OF THE PREFERRED EMBODIMENTS

### Table Listing Subsections of Detailed Description

A table of subsections for the detailed description is set out below.

Table of Subsections

```
Table Listing Subsections of Detailed Description
Introductory Notes
General Description
Chassis
Connector
Main Support Assembly
      Main Elevator/Lift Assembly
      Main Wheel Assembly
Methods and Manners of Use
Interpretation Notes
```

### Introductory Notes

The readers of this document should understand that the embodiments described herein may rely on terminology used in any section of this document and other terms readily apparent from the drawings and the language common therefor as may be known in a particular art and such as known or indicated and provided by dictionaries. Dictionaries were used in the preparation of this document. Widely known and used in the preparation hereof are Webster's Third New International Dictionary (©1993), The Oxford English Dictionary (Second Edition, ©1989), and The New Century Dictionary (©2001-2005), all of which are hereby incorporated by reference for interpretation of terms used herein and for application and use of words defined in such references to more adequately or aptly describe various features, aspects and concepts shown or otherwise described herein using more appropriate words having meanings applicable to such features, aspects and concepts.

This document is premised upon using one or more terms or features shown in one embodiment that may also apply to or be combined with other embodiments for similar structures, functions, features and aspects of the invention and provide additional embodiments of the inventions. The readers of this document should further understand that the embodiments described herein may rely on terminology and features used in any section or embodiment shown in this document and other terms readily apparent from the drawings and language common or proper therefor.

Wording used in the claims is also descriptive of the invention and the text of both claims and abstract are incorporated by reference into the description entirely in the form as originally filed. Terminology used with one, some, or all embodiments may be used for describing and defining the technology and exclusive rights associated herewith.

### General Description

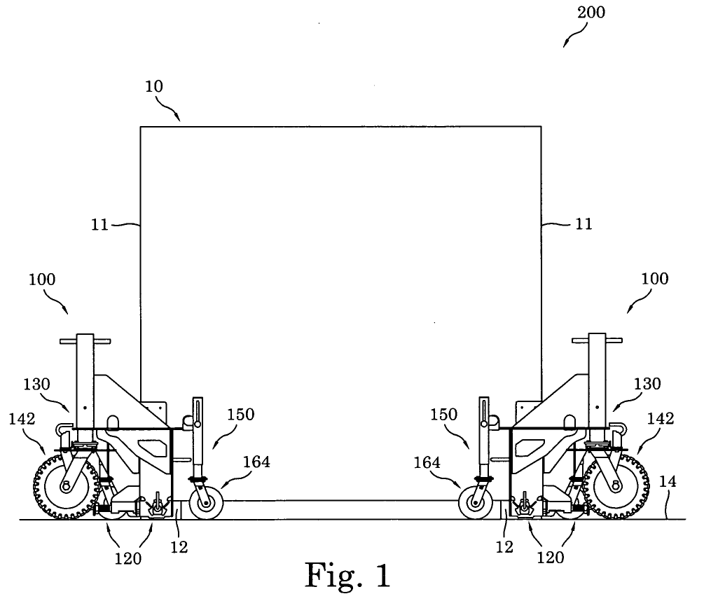

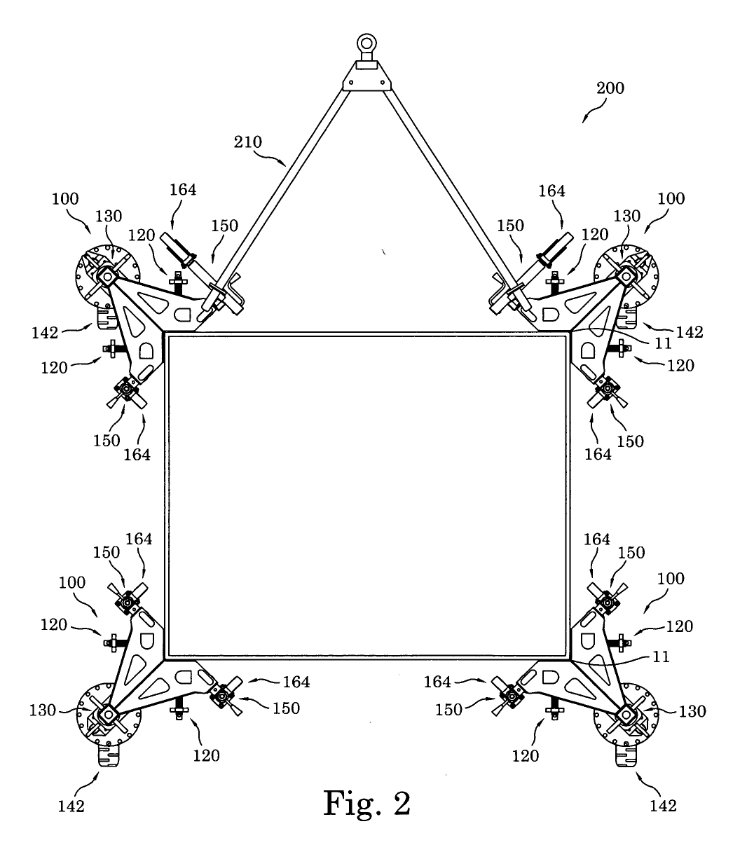

With reference to FIGS. 1 and 2, an elevation view and a plan view are shown, respectively, of apparatus 100 and a system 200 according to a preferred embodiment of the instant inventions. The apparatus 100 and/or system 200 are intended to be used with a shipping container 10. The shipping container is generally in the form of a box having four substantially vertical corner edges 11. According to a preferred embodiment of the inventions, the shipping container has four bottom corner fittings 12. The bottom corner fittings 12 are ISO 1161 corner fittings, according to a preferred embodiment of the inventions. Dimensions, configurations and other characteristics of shipping containers, as well as ISO standards pertaining thereto, are well known to those of ordinary skill in the art and/or are easily obtainable from various sources.

In accordance with one aspect of the inventions, the apparatus 100 is adapted to connect to a respective corner 11 of a shipping container 10. Preferably, the apparatus is adapted to connect to a bottom corner fitting 12 of a shipping container. Each apparatus 100 is adapted to support at least a portion of a shipping container and its contents on a surface 14 such as the ground or surface of the earth. For example, it is contemplated that the apparatus is adapted for use with ISO TriCon and QuadCon containers on unimproved and/or unpaved surfaces such as those encountered during military operations in remote areas. Preferably, the apparatus 100 is adapted to perform as described herein while engaged with and/or connected to only a respective bottom corner of a container. For example, the apparatus 100 is preferably adapted to support at least a portion of a container 10 substantially as described herein while being engaged with and/or connected to only the bottom corner and/or corner fitting 11 of the container.

According to an exemplary embodiment of the inventions, a plurality of apparatus 100 can be employed with a shipping container, wherein each apparatus is connected to a respective lower corner fitting of a container, such as a TriCon or QuadCon. In accordance with such an embodiment, the apparatus is adapted to connect to a container that has been delivered by air, such as by a helicopter, to a remote, unimproved location. The apparatus is adapted to facilitate recovery of the container and/or positioning of the container in a desired location. For example, each of a group of four apparatus 100 can be connected, respectively, to each of four bottom corner fittings of a container 10, as shown. In accordance with at least one embodiment of the inventions, the container 10 can be a TriCon. After connection of the apparatus 100 to the container 10, the container can be raised so as to be supported on unimproved ground by way of the four apparatus 100. The container can then be relocated to a desired location by moving the apparatus across the ground 14, which can be facilitated by a rolling action provided by at least one wheel of each apparatus.

### Chassis

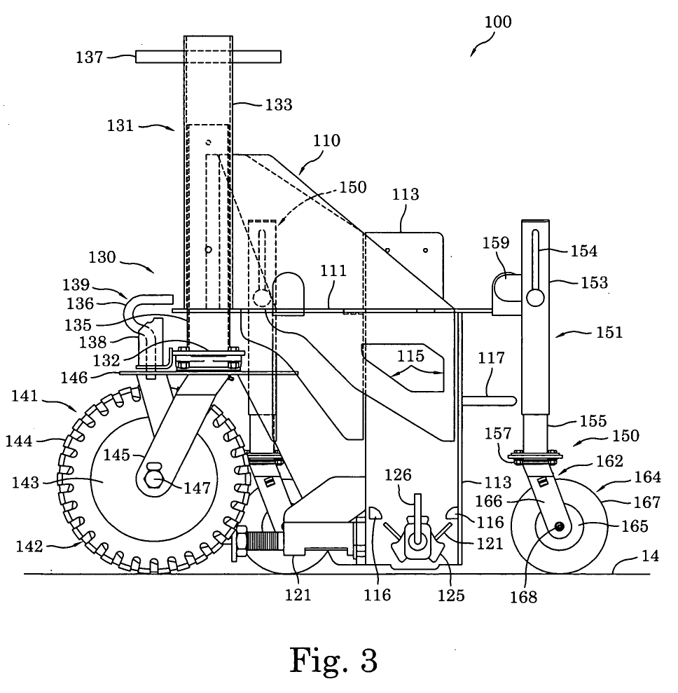

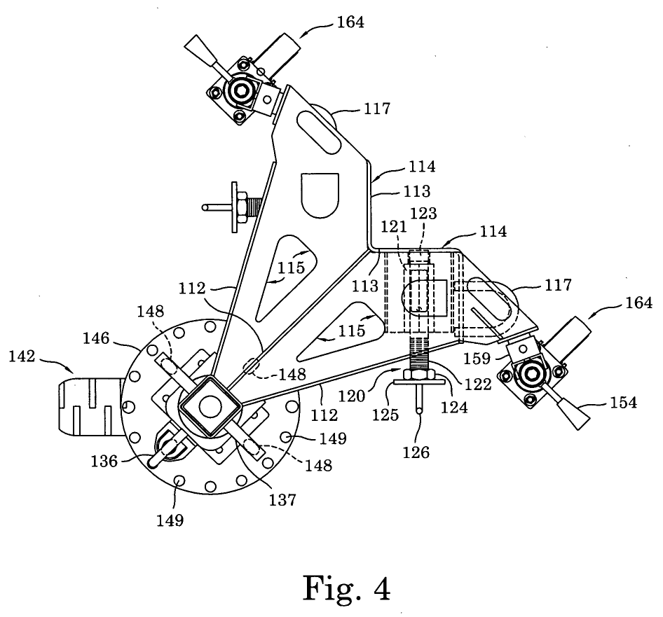

With reference now to FIGS. 3 and 4, an elevation view and a plan view are shown, respectively, in which an apparatus 100 is depicted according to one aspect of the instant inventions. It is to be noted that, for the purpose of illustrative clarity, some components depicted in FIGS. 3 and 4 are shown with different respective orientations. Such components include, but are not necessarily limited to components labeled 131, 132, 133, 135, 136, and 137. Specifically, at least the aforementioned components are depicted in FIG. 3 as being approximately forty-five degrees of rotation (or about one-eighth of a turn), in a clockwise direction, from the actual angular position, which is depicted in FIG. 4.

Still referring to FIGS. 3 and 4, the apparatus 100 includes a chassis 110. The chassis is preferably adapted to be rugged enough to support at least a substantial portion of a shipping container 10 (shown in FIGS. 1 and 2) and its contents, when generally employed in one or more manners depicted and/or described herein. With reference to FIGS. 3 and 4, the chassis 110 is preferably constructed or fabricated from a substantially rigid and durable material. For example, the chassis can be made of a steel material.

In accordance with the exemplary embodiment of the inventions, the chassis 110 is built up from a plurality of steel plates that are cut to a predetermined shape and/or size. Such a plurality of steel plates are preferably permanently connected together to form a chassis assembly. More preferably, such a plurality of steel plates is permanently assembled together by welding or other such suitable process. For example, the chassis 110 can include one or more deck members 111. The deck member 111 has a substantially horizontal orientation according to the preferred embodiment of the inventions. The deck member is preferably cut from flat steel plate material.

The chassis 110 can further include one or more upright members 112. The upright members preferably have an upright or substantially vertical orientation. The upright members are preferably cut from flat steel plate material. The chassis 110 includes at least one bearing member 113 in accordance with the preferred embodiment of the inventions. The bearing member preferably has a substantially vertical orientation as depicted. The bearing member 113 is preferably formed to create at least one interior corner as is depicted in the accompanying drawing figures. The bearing member is preferably formed from steel plate and/or fabricated from steel angle material.

Still referring to FIGS. 3 and 4, at least one bearing surface 114 is defined on the bearing member 113. The bearing surface is adapted to engage with, and to bear against, a shipping container 10 with which the apparatus is used, as is described further hereinbelow. More preferably, the bearing surface 114 is adapted to engage and/or bear against a corner edge 11 (shown in FIG. 1) of a shipping container 10, or to engage and/or bear against an area of the container substantially proximate the corner edge. The bearing surface 114 is preferably divided into two flat facets or faces as shown, which are preferably substantially normal, or perpendicular to each other as depicted in FIG. 4. For example, according to the exemplary embodiment of the inventions, the bearing surface 114 forms an interior or inside corner that is preferably a right angle corner as shown.

According to at least one alternative embodiment of the inventions not shown in the accompanying drawing figures, one or more pads or other types of bearing material can be supported on the bearing surface. In accordance with such alternative embodiments of the inventions, the pads or bearing material (not shown) are adapted to come into direct contact with a container and are situated substantially between the container and the bearing member when the apparatus is connected to the container. For example, such pads can be high density plastic or rubber material.

With continued reference to FIGS. 3 and 4, one or more sighting apertures 116 are preferably defined in the bearing member 113. The sighting apertures are described in greater detail hereinbelow. In accordance with the exemplary embodiment of the inventions, the bearing member 113, one or more deck members 111, and one or more upright members 112 are welded together in the general arrangement depicted so as to form the chassis. A study of FIGS. 3 and 4 reveals that the deck member and upright member preferably each define one or more openings 115. The openings 115 are preferably configured to provide weight reduction of the chassis, while also not substantially decreasing durability and/or strength of the chassis.

The chassis 110 preferably includes at least one hitch portion 117. In accordance with the preferred embodiment of the inventions, the hitch portion is substantially in the form of a loop. For example, the hitch portion 117 can be substantially in the form of a D-ring or half-oval as depicted. Preferably, the hitch portion is formed from steel rod and is welded or otherwise attached to a portion of the chassis. The hitch point is preferably adapted to serve as an attachment or hitching point for a tow bar or the like as is described further hereinbelow. It is to be understood that the chassis 110 can include additional or alternative features and/or elements that are not specifically described herein. Such features and/or elements can include, but are not limited to, gussets, webs, reinforcement members, tabs, assembly holes, fastening holes, and the like.

### Connector

With continued reference to FIGS. 3 and 4, the apparatus 100 includes at least one connector 120. Preferably, a plurality of connectors are included in the apparatus. More preferably, the apparatus includes a pair of connectors as shown. According to the preferred embodiment of the apparatus, the apparatus includes a pair of connectors that are arranged in a substantially normal or perpendicular orientation to each other. Preferably, each of the connectors 120 is positioned in a substantially normal or perpendicular orientation to a respective portion or facet of the bearing surface 114, as is readily seen from study of FIG. 4. For example, as shown, each of the connectors 120 is preferably positioned proximate an associated portion or facet of the bearing surface.

Each connector 120 is preferably configured to engage and connect with a bottom corner fitting 12 of a shipping container 10. More preferably, each of the connectors is adapted to engage and connect with an associated side aperture of a bottom corner fitting of a shipping container. Each connector preferably functions to selectively hold the bearing surface fast against a respective corner of a shipping container. According to the exemplary embodiment of the inventions, the connectors of the apparatus function to substantially rigidly connect or attach the apparatus to a shipping container.

Each connector 120 preferably includes a carrier 121. The carrier is substantially permanently attached to the chassis 110 according to the exemplary embodiment of the apparatus. For example, the carrier 121 is preferably fabricated from a steel material that is welded to the chassis 110. More preferably, the carrier 121 is supported by the bearing member 113 as depicted in the accompanying drawing figures. In accordance with the exemplary embodiment of the inventions, the carrier 121 is formed from two lengths of steel angle, as is seen from a study of FIGS. 3 and 4.

The connector also preferably includes a shaft 122, at least a portion of which can be threaded as shown. The carrier 121 and shaft 122 are configured such that the shaft is both slidable in an axial direction, and also rotatable, relative to the carrier. The connector preferably includes a handle 126 connected to the shaft 122, which is preferably adapted to facilitate manual rotational and axial movement of the shaft during operation of the connector. The connector further preferably includes a head or lug 123. The head or lug is preferably connected to an end of the shaft 122 as shown. More preferably, the head or lug is integrally formed on an end of the shaft. The head is preferably oblong or oval in shape. More preferably, the shape of the head is substantially similar to that of a corner fitting side aperture to which it is to be engaged. The head or lug is also preferably slightly smaller in size so that the head can fit into the side aperture when properly oriented.

In order to engage the connector 120 with a corner fitting 12 of a container 10, the head 123 can be inserted into an aperture of the corner fitting with the head being substantially aligned with the aperture. After such insertion of the head into the aperture, the shaft and the head can be rotated. Preferably the shaft and head are rotated about ninety degrees, or one-quarter of a turn. After the head is inserted into the aperture and is rotated, the head preferably cannot be withdrawn from the aperture until the head is again substantially aligned with the aperture by rotation back to its original aligned orientation with the aperture.

The connector 120 preferably includes a selectively operable keeper or lock 124 adapted to substantially keep the shaft 122 in a desired position relative to the carrier. According to the preferred embodiment of the inventions, the lock is substantially in the form of a threaded nut that is engaged with corresponding threads on the shaft 122 as shown. A tapping ring 125 can be welded or otherwise connected to the nut in order to facilitate turning the nut by hand and/or tapping with a hammer to tighten or loosen the keeper or nut 124. According to the preferred embodiment, the nut 124 can be tightened against the carrier 121 when the head 123 is engaged with a corner fitting 12 of a shipping container 10. Tightening the nut in this manner can cause the head to be pulled against an interior surface of a corresponding corner fitting, thus resulting in substantial binding the head against the interior surface. Conversely, this preferably acts to substantially bind the bearing surface 114 against the corner of the container.

### Main Support Assembly

With continued reference to FIGS. 3 and 4, the apparatus 100 includes a main support assembly 130. Included in the main support assembly is an elevator or lift assembly 131 and a wheel assembly 141. The wheel assembly includes at least one main wheel 142 that is adapted to be operably supported upon a surface 14 such as the ground, or surface of the earth. More specifically, the wheel assembly 141 is preferably adapted to movably support the chassis 110 and at least a portion of a shipping container on the ground or other support surface 14. The lift or elevator assembly 131 is preferably adapted to provide selective elevation adjustment of the wheel 142 relative to the chassis 110. More specifically, the elevator/lift assembly 131 is preferably adapted to provide for selectively raising and lowering the chassis along with at least a portion of a shipping container 10 (shown in FIGS. 1 and 2) relative to the surface 14 upon which the wheel assembly 142 rests.

### —Main Elevator/Lift Assembly

The elevator/lift assembly 131 preferably includes a first portion 133 and a second portion 135. Preferably, the first portion is an upper portion and the second portion is a lower portion. The first portion is preferably attached to the chassis 110. For example, the first portion 133 is welded to the chassis according to the exemplary embodiment of the inventions. The second portion 135 is movably engaged with the first portion. Selective activation of the elevator/lift assembly preferably causes the second portion 135 to move relative to the first portion 133. Movement of the second portion relative to the first portion can be accomplished by way of an activation mechanism (not shown), for example. The first portion and second portion together preferably make up, or are substantially in the form of, a jack such as a screw jack for example.

According to the exemplary embodiment of the inventions, the second portion 135 is preferably adapted to slidably fit substantially within the first portion 133 as shown. More specifically, the second portion is adapted for substantial telescopic movement with respect to the first portion. Such telescopic movement of the second portion is preferably accomplished by way of an elevation adjustment mechanism (not shown) that is internal to the first and/or second portions. Preferably, the first and second portions 133, 135 have a substantially vertical orientation when the apparatus is substantially level, as is depicted in FIG. 3. According to the preferred embodiment of the inventions, each of the first and second portions 133, 135 are substantially in the form of a respective length of tubing, as is shown in FIGS. 3 and 4.

Activation of the elevator/lift assembly can be accomplished by way of an input member 137. The input member 137 is preferably in the form of a rotatable input shaft as shown. Preferably, rotation of the input shaft 137 results in a corresponding movement of the second portion 135 relative to the first portion 133. Specifically, rotation of the input member in a first direction preferably results in extension of the second member relative to the first member, while rotation of the input member in a second, or opposite, direction preferably results in retraction of the second member into the first member. Rotation of the input member 137 can preferably be accomplished manually by way of a crank handle (not shown) or the like that can be connected to the input shaft. Alternatively, a motor (not shown) or other such actuating means can be connected to the input shaft for powered rotation of the input shaft.

With continued reference to FIGS. 3 and 4, the elevator/lift assembly 131 can include a steerage mechanism 132. The steerage mechanism is preferably adapted to facilitate steerage of the wheel assembly 141 and/or steerage of the main wheel 142. Preferably, the steerage mechanism 132 is supported by the second portion 135 of the elevator/lift assembly. More preferably, the steerage mechanism 132 is attached to a distal end of the second portion 135, as depicted. According to the preferred embodiment of the inventions, the steerage mechanism includes, or is substantially in the form of, a bearing and/or turntable that allows swiveling or pivoting of the wheel assembly 141 relative to the chassis 110. Accordingly, steerage of the wheel assembly is preferably provided by allowing free pivoting or swiveling as in the manner of a caster wheel.

The elevator/lift assembly 131 preferably includes at least a portion of a steering lock mechanism 139. The steering lock mechanism includes a pin 136 according to the preferred embodiment of the inventions. The pin can be bent or formed into a shape, such as that depicted in FIG. 3, which facilitates ease of manual operation. The steering lock mechanism 139 also preferably includes a guide 138. According to the preferred embodiment of the inventions, the pin 136 is slidably retained in the guide in the manner depicted. Additional elements and aspects of the steering lock mechanism 139, including the intended function thereof, is described hereinbelow.

—Main Wheel Assembly

With continued reference to FIGS. 3 and 4, the wheel assembly 142 is preferably rotatably supported on the elevator/lift assembly 131. More preferably, the wheel assembly is supported on the second portion 135 of the elevator/lift assembly. According to the exemplary embodiment of the inventions, the wheel assembly 142 is supported on a distal end of the second portion 135 of the elevator/lift assembly 131 as is seen from a study of FIG. 3. With continued reference to both FIGS. 3 and 4, the wheel assembly is preferably connected to the steering mechanism 132 so as to facilitate steerage of the main wheel 142.

The main wheel assembly 141 preferably includes a wheel support 145. The wheel support is substantially in the form of a fork or clevis, according to the exemplary embodiment of the inventions. The wheel support 145 is preferably supported by the steerage mechanism 132 so as to allow pivoting or swiveling of the wheel support relative to the chassis 110. The wheel assembly preferably includes an axle or spindle 147. The axle or spindle is preferably positioned on the wheel support 145 as shown. The axle or spindle can include one or more forms of bushing or bearings to facilitate rotation of the main wheel 142.

The main wheel 142 is preferably rotatably supported on the axle or spindle 147. The main wheel can include one or more forms of bushings or bearings to facilitate rotation of the main wheel about the axle or spindle. The main wheel includes a wheel center portion or hub 143 according to the exemplary embodiment of the inventions. Preferably, the wheel center portion 143 is rotatably supported on the spindle or axle 147. The exemplary embodiment of the inventions includes a tire 144 that is supported about the wheel center portion 143. Preferably, the tire 144 and wheel center portion 143 are separate components. However, according to at least one alternative embodiment of the inventions not specifically depicted herein, the tire and wheel center portion are substantially integrated into a substantially unitary component.

Still referring to FIGS. 3 and 4, an apparatus 100 according to the preferred embodiment of the inventions includes a latch plate 146. Preferably, the latch plate is attached to the wheel support 145. Thus, according to the preferred embodiment of the inventions, the latch plate 146 is adapted to pivot or swivel along with the wheel support relative to the chassis 110. The latch plate preferably makes up a portion of the steering lock mechanism 139. More specifically, the latch plate is preferably adapted to cooperatively function with the pin 136 to provide substantially selective locking of the wheel 144 in a selected and/or predetermined steering orientation. For example, the lock 139 is preferably adapted to limit steerage of the wheel 142 and/or wheel assembly 141 to at least one selected and/or predetermined orientation.

According to the preferred embodiment of the inventions, the latch plate 146 defines a plurality of lock apertures 148. Each of the lock apertures is preferably adapted to accept the at least a portion of the pin 136 to thereby substantially limit the wheel support 145 to at least one selected steering orientation or direction relative to the chassis 110. The latch plate 146 also includes at least one handle connection feature 149. Preferably, the latch plate 146 includes a plurality of handle connection features 149 arranged substantially evenly about the periphery of the latch plate, as shown. The handle connection features are preferably in the form of holes or apertures, as is depicted. The handle connection features are preferably adapted to facilitate connection of a handle (described hereinbelow) to the apparatus 100.

### Secondary Support Assembly

With reference to FIGS. 1-4, the apparatus 100 includes at least one secondary support assembly 150. The secondary support assembly is preferably adapted to facilitate moving and/or positioning the apparatus prior to engagement with and/or attachment to a shipping container 10. More specifically, the secondary support assembly is preferably adapted to aid in supporting the apparatus when the apparatus is not fully connected or attached to a shipping container. The apparatus 100 preferably includes a plurality of secondary support assemblies 150. The exemplary embodiment of the inventions includes two secondary support assemblies as shown in the accompanying drawing figures.

The exemplary secondary support assembly 150 includes a secondary elevator/lift assembly 151. The secondary elevator/lift assembly can be configured and/or can be adapted to function in a manner similar to that of the primary elevator/lift assembly 131, which is described hereinabove. The exemplary secondary support assembly 150 includes a wheel assembly 162. The wheel assembly 162 is preferably operatively connected to the elevator/lift assembly 151, as shown. The secondary wheel assembly 162 can be configured and/or can be adapted to function in a manner similar to that of the primary wheel assembly 141, which is described hereinabove. The secondary elevator/lift assembly 151 is preferably adapted to provide selective elevation adjustment of the wheel assembly 162. The secondary wheel assembly 162 includes at least one secondary wheel 164.

The secondary elevator/lift assembly 151 preferably includes a first portion 153 and a second portion 155. The first portion is preferably attached to the chassis 110. According to the exemplary embodiment of the inventions, the first portion 151 is connected to the chassis by way of a mount 159. The mount is preferably adapted to selectively pivot or swivel. More specifically, the mount is preferably adapted to enable the secondary support 150 to be pivoted into a raised or stowed position. For example, according to the exemplary embodiment of the inventions, the secondary support assembly 150 is capable of being selectively rotated or pivoted to a stowed position which is approximately ninety degrees in a clockwise direction from the position depicted in FIGS. 3 and 4. The stowed position of the support assembly is preferably utilized after the apparatus 100 is connected with a shipping container. A depiction of such a stowed position of the secondary support assembly 151 is seen from a careful study of FIG. 2.

With continued reference to FIGS. 1-4, the second portion 155 of the secondary elevator/lift assembly is preferably movably engaged with the first portion 153. More specifically, the secondary elevator/lift assembly 151 is preferably configured so that selective activation thereof causes the second portion 155 to move relative to the first portion 153. Such movement of the second portion 155 relative to the first portion 153 can be accomplished by way of an activation mechanism (not shown), for example. For example, the first portion and second portion can together be substantially in the form of a jack.

According to the exemplary embodiment of the inventions, the first portion 153 and second portion 155 can make up respective parts of a screw jack. For example, the second portion is preferably adapted to slidably fit substantially within the first portion as shown. More specifically, the second portion is adapted for substantial telescopic movement with respect to the first portion. Such telescopic movement of the second portion 155 is preferably accomplished by way of a screw jack mechanism (not shown) that is internal to the first and/or second portions. Preferably, the first and second portions 153, 155 have a substantially vertical orientation when deployed in respective operating positions, as is depicted in FIGS. 3 and 4. According to the preferred embodiment of the inventions, each of the first and second portions 153, 155 are substantially in the form of a respective length of tubing, as is shown.

Activation of the elevator/lift assembly can be accomplished by way of an input member 154. The input member 154 is preferably in the form of a rotatable input shaft or crank handle as shown. Accordingly, a rotation of the input member 154 preferably results in a corresponding movement of the second portion 155 relative to the first portion 153. Specifically, rotation of the input member in a first direction preferably results in movement or extension of the second member relative to the first member. Similarly, rotation of the input member in a second, or opposite, direction preferably results in retraction of the second member relative to the first member. Rotation of the input member 154 can be accomplished manually according to the exemplary embodiment of the inventions. Alternatively, a motor (not shown) or other actuating means can be connected to the input shaft for powered rotation of the input shaft.

With continued reference to FIGS. 3 and 4, the secondary elevator/lift assembly 151 includes a steerage mechanism 157. The steerage mechanism is adapted to facilitate steerage of the wheel assembly 162 and/or steerage of the secondary wheel 164. Preferably, the steerage mechanism is supported by the second portion 155 of the secondary elevator/lift assembly. More preferably, the steerage mechanism is attached to a distal end of the second portion 155, as depicted. According to the preferred embodiment of the inventions, the steerage mechanism includes, or is substantially in the form of, a bearing and/or turntable that allows swiveling or pivoting of the wheel assembly 162 relative to the chassis 110. Accordingly, steerage of the wheel assembly 162 is preferably provided by allowing free pivoting or swiveling as in the manner of a caster wheel.

With continued reference to FIGS. 3 and 4, the secondary wheel assembly 162 is operably supported on the secondary elevator/lift assembly 151. More preferably, the secondary wheel assembly is supported on the second portion 155 of the secondary elevator/lift assembly. According to the exemplary embodiment of the inventions, the secondary wheel assembly 162 is supported on a distal end of the second portion of the secondary elevator/lift assembly as is seen from a study of FIG. 3. With continued reference to both FIGS. 3 and 4, the secondary wheel assembly is preferably connected to the secondary steering mechanism 157 so as to facilitate steerage of the secondary wheel 164.

The secondary wheel assembly 162 preferably includes a secondary wheel support 166. The wheel support is substantially in the form of a fork or clevis, according to the exemplary embodiment of the inventions. The wheel support 166 is preferably supported by the steerage mechanism 157 so as to allow pivoting or swiveling of the wheel support relative to the chassis 110. The secondary wheel assembly 162 preferably includes an axle or spindle 168. The axle or spindle is preferably positioned on the wheel support as shown. The secondary axle or spindle 168 can include one or more forms of bushing or bearings to facilitate rotation of the secondary wheel 164.

Still referring to FIGS. 3 and 4, the secondary wheel 164 is preferably rotatably supported on the axle or spindle 168. The secondary wheel can include one or more forms of bushings or bearings (not shown) to facilitate rotation of the wheel about the secondary axle or spindle. The secondary wheel 164 includes a respective wheel center portion or hub 165, according to the exemplary embodiment of the inventions. Preferably, the wheel center portion 165 is rotatably supported on the spindle or axle 168. The exemplary embodiment of the inventions includes a secondary tire 167 that is supported about the wheel center portion 165. Preferably, the tire 167 and wheel center portion 165 are separate components. However, according to at least one alternative embodiment of the inventions not specifically depicted herein, the tire and wheel center portion are integrated into a substantially unitary component.

It is noted that the two secondary wheels 164 together with the main wheel 142 form a triangular shape or pattern when viewed from above, according to the exemplary embodiment depicted in FIG. 4. More specifically, it is seen from a study of FIGS. 3 and 4 that the respective points of contact between the ground 14 and the wheels 142, 164 form a triangular footprint. According to the exemplary embodiment of the inventions, this triangular footprint formed by the wheels 142, 164 is substantially close to an equilateral triangle in its proportions.

### System

With reference now to FIGS. 1 and 2, an elevation view and a top view of a system 200 are depicted in accordance with a preferred embodiment of the inventions. The system 200 includes a plurality of apparatus 100, as shown. Each of the apparatus 100 is adapted for connection or attachment to a shipping container 10. More specifically, each apparatus is preferably adapted for connection or attachment to a respective bottom corner fitting 12 of a shipping container, such as an ISO container. The system 200 includes the shipping container 10 according to at least one embodiment of the inventions. In accordance with the preferred embodiment, the ISO container can be a TriCon or a QuadCon, for example. Specifications of shipping containers and components thereof, including corner fittings, and particularly ISO specifications, are well known to those of ordinary skill in the art and/or are readily available from various sources.

Still referring to FIGS. 1 and 2, the system 200 preferably includes a tow bar 210. The tow bar can be attached as desired to one or more of the apparatus 100 for towing. For example, the tow bar can be employed when a motor vehicle (not shown) is available for towing or otherwise supplying motive power to the shipping container and/or the apparatus 100. In accordance with the exemplary embodiment of the system 200, the tow bar 210 is adapted for selective attachment to two adjacent apparatus 100 as shown in FIG. 2. The tow bar 210 is preferably configured to be foldable. In this manner, the tow bar can be placed into a folded position when not in use for convenient stowage or transport.

### Handle

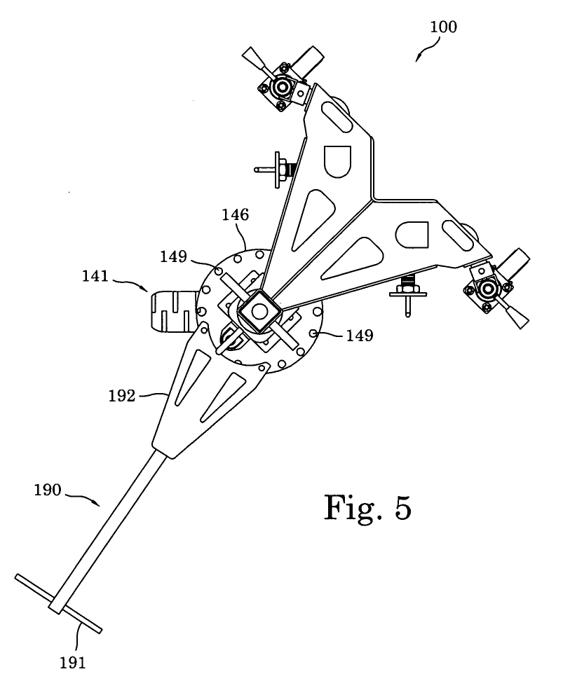

With reference now to FIG. 5, a top view of the apparatus 100 is shown with an optional handle 190 attached thereto. The basic handle 190 can be substantially in the form of a bar or shaft, as shown. The handle preferably includes a grip 191 attached thereto. More preferably, the handle and grip together are substantially in the form of a T-bar, as depicted. The handle is preferably adapted to facilitate pushing and/or pulling the apparatus 100. The handle preferably includes an attachment bracket 192. The attachment bracket includes one or more features or aspects adapted to facilitate operable attachment of the handle to the apparatus. Preferably, the handle 190 is adapted for attachment to the main wheel assembly 141 of the apparatus 100. In this manner, the handle 190 can be employed to actively steer the main wheel assembly. In accordance with the exemplary embodiment, the handle 190 is selectively attachable to the latch plate 146. Preferably, the handle is attachable to the handle connection features 149. For example, the handle connection features 149 are in the form of substantially round apertures defined in the latch plate 146, according to the preferred embodiment of the inventions. Also, 605 according to the preferred embodiment, the attachment bracket 192 of the handle 190 includes a pair of pins (not shown) adapted to connectively fit into associated apertures 149 defined in the latch plate 146.

### Methods and Manners of Use

With reference now to FIGS. 1-5, a plurality of apparatus 100 are employed for moving a shipping container 10. The shipping container is either a TriCon or a QuadCon according at least one preferred embodiment of the inventions. In accordance with at least one embodiment of the inventions, the shipping container is delivered to a remote location by air transport, such as a helicopter (not shown) for example. In many instances, the shipping container can be slung beneath a helicopter having the capacity for lifting the shipping container and its contents. The shipping container can thus be transported to the desired general location, where it is set down upon the surface of the earth 14 and released from the helicopter.

Depending upon the force with which the shipping container is set on the ground, one or more of the bottom corner fittings 12 of the container 10 can be beneath or partially beneath the grade level 14. In such an instance, the earth and/or debris surrounding those bottom corner fittings of the container that are below or partially below grade level are preferably excavated. For example, excavation of the bottom corner fittings 12 can be accomplished manually by using a shovel. Excavation is preferably accomplished to a degree which provides sufficient clearance for the connectors 120 and chassis portions proximate thereto.

With continued reference to FIGS. 1-5, one of the apparatus 100 is selected for attachment to an associated bottom corner fitting 12 of the container 10. Prior to attachment of the apparatus 100 with the container 10, the apparatus preferably rests upon the main support assembly 130 as well as the secondary support assemblies 150, as depicted in the accompanying figures. The selected apparatus 100 is preferably manually pushed or wheeled up to the associated corner edge 11 of the container. If desired, the bearing surface 114 can be substantially angularly aligned with the associated corner edge of the shipping container. This can be accomplished by first positioning the apparatus 100 relative to the container 10 so as to place the bearing surface 114 in close proximity to the associated corner edge 11 of the shipping container, and then by adjusting one or more of the main elevator/lift assembly 131 and/or secondary elevator/lift assembly 151. Such adjustments of the main and secondary elevator/lift assemblies are preferably made until the bearing surface 114 is in substantial angular alignment with the associated corner edge 11 of the shipping container.

According to a preferred manner of use, elevation of the connectors 120 is adjusted to position the connectors within substantial proximity of the associated bottom corner fitting apertures to which the connectors are to be engaged. Such positioning of the connectors is preferably accomplished by adjusting the main elevator/lift assembly 131 and/or secondary elevator/lift assembly 151 while also maintaining the previously attained angular orientation of the bearing surface. If the associated bottom corner fitting 12 is below or partially below grade level 14, then the connectors 120 can be lowered below grade level by appropriate adjustment of the main and/or secondary elevator/lift assemblies 131, 151, respectively.

Proper elevation of the connectors 120 relative to the corner fittings 12 can be preferably facilitated by use of the sight apertures 116 described hereinabove. For example, the main elevator/lift assembly 131 and/or the secondary lift assemblies 151 can be adjusted to position the lower edge of each sight aperture 116 with the upper edge of the respective bottom corner fitting 12. Alignment for elevation with respect to the connectors 120 and respective bottom corner fittings 12 in this manner can facilitate ease of connective engagement of the connectors with the corner fittings.

The connectors 120 are preferably connectively engaged with the associated bottom corner fitting 12 after the connectors have been placed into sufficient proximity and alignment with the associated bottom corner fitting 12 of the container 10. Connective engagement of the connectors 120 with the associated bottom corner fitting 12 can be accomplished by first orienting the head 123 of each connector so as to substantially rotationally align with the orientation of the respective bottom corner fitting aperture. Such alignment of the head or lug 123 can be accomplished by rotating or pivoting the respective shaft 122. Rotation of the shaft is preferably accomplished by way of the associated handle 126 attached thereto. After alignment, the lug or head 123 is then preferably inserted into the associated aperture by longitudinally sliding the respective shaft 122 relative to the shaft carrier 121.

After insertion of the head or lug 123 into the associated bottom corner fitting aperture, the shaft 122 is preferably rotated approximately ninety degrees, or one-quarter turn. This preferably places the head or lug in an engaged position relative to the bottom corner fitting. With the head or lug in the engaged position, the lock 124 is preferably activated. In this manner, each connector 120 is preferably connectively engaged with the associated bottom corner fitting 12 of the shipping container 10. After connective engagement of the connectors 120 with the associated corner fittings 12, the secondary wheel assemblies 164 are preferably elevated relative to the chassis 110. Elevation of the secondary wheel assemblies can be accomplished by selective adjustment of the respective secondary elevator/lift assembly 151. The secondary support assembly 150 is preferably rotated to a stowed position, which is seen in FIG. 2 with a careful study thereof. Placement of the secondary support assembly into a stowed position can be accomplished by selectively pivoting the secondary support assembly about the respective mount 159, according to the exemplary embodiments of the inventions.

Engagement and/or connection of each apparatus 100 with the container 10 is preferably accomplished substantially in the manner described hereinabove. According to the preferred embodiment of the inventions, four apparatus 100 are part of a system 200 that is connectively engaged with the shipping container 10, wherein each apparatus is engaged with an associated corner 11 of the container. Upon connection of the apparatus 100 with the shipping container 10, each of the main wheel assemblies 141 is lowered relative to the respective chassis 110 so as to raise the chassis relative with the ground 14. The wheel assembly 141 is preferably lowered by selective adjustment of the respective main elevator/lift assembly 130. Selective lowering of the main wheel assemblies 141 of each of the apparatus 100 connected to the container preferably results in the container being raised off the ground. Preferably, the bottom of the container is raised to a height sufficient to clear any obstructions that may lie in the path of the container.

With the shipping container 10 raised off the ground 14, it will preferably be supported on a plurality of apparatus 100. The shipping container can thus be moved across the ground by pushing and/or pulling the container and/or one or more of the plurality of apparatus connected thereto. In accordance with the exemplary embodiment of the inventions, the system 200, when pushed or pulled, will supportably roll across the surface 14 on which it is supported. Such rolling is accomplished by way of a plurality of main wheels 142 rolling across the surface. Motive force required for moving the system can be provided by manual pushing and/or pulling against one or more of the container 10 and/or the apparatus 100. At least one handle 190 (shown in FIG. 5) can be employed to facilitate pushing and/or pulling and/or steerage of the system and/or apparatus.

Additional and/or alternative motive force can be provided by a power source such as a motor vehicle (not shown), for example. Such a power source can be employed to push and/or pull the container 10 and/or the apparatus 100. Pushing and/or pulling the apparatus can be accomplished in conjunction with the bar 210. For example, the bar 210 can be coupled with the apparatus 100 as depicted in FIG. 2. The bar 210 can also be coupled, for example, with a power source (not shown) such as a motor vehicle. Alternative means of moving the system 200 and/or apparatus 100 can be provided in conjunction with other components and/or device not specifically depicted or described herein. For example, a heavy chain (not shown) can be coupled between a motor vehicle and one or more of the apparatus 100 to accomplish pulling of one or more of apparatus 100 and a shipping container 10. The handle depicted in FIG. 5 can be employed in conjunction with any of the motive means discussed herein to facilitate steerage of the apparatus and/or system.

### Interpretation Notes

The above description has set out various features, functions, methods and other aspects of the inventions. This has been done with regard to the currently preferred embodiments thereof. Time and further development may change the manner in which the various aspects are implemented. Such aspects may further be added to by the language of the claims which are incorporated by reference hereinto as originally filed.

The scope of protection accorded the inventions as defined by the claims is not intended to be necessarily limited to the specific sizes, shapes, features or other aspects of the currently preferred embodiments shown and described. The claimed inventions may be implemented or embodied in other forms while still being within the concepts shown, described and claimed herein.

I claim:

1. An apparatus for use with a shipping container, comprising:
a substantially rigid chassis;
a first connector supported by the chassis and adapted to connectively engage a bottom corner fitting of the shipping container;
a second connector supported by the chassis and adapted to connectively engage the bottom corner fitting of the shipping container;
a bearing surface adapted to bear against a corner of the shipping container substantially above the corner fitting;
a main support assembly connected to the chassis, the main support assembly comprising a main wheel adapted for adjustment in elevation relative to the chassis;
a plurality of secondary support assemblies connected to the chassis, each secondary support assembly comprising a secondary wheel adapted for adjustment in elevation relative to the chassis.

2. The apparatus according to claim 1 the apparatus comprising two secondary wheels that, together with the main wheel, form a substantially triangular footprint on a support surface when resting thereupon.

3. The apparatus according to claim 1 wherein the first connector and the second connector are arranged in a substantially normal orientation relative to each other.

4. The apparatus according to claim 1 wherein the apparatus is adapted to selectively position the first connector and the second connector below a surface upon which the main wheel and the secondary wheels are adapted to rest.

5. The apparatus according to claim 1 further comprising a steering mechanism positioned between the main wheel and the chassis, the steering mechanism adapted to facilitate steerage of the main wheel.

6. The apparatus according to claim 1 further comprising:
a steering mechanism positioned between the main wheel and the chassis, the steering mechanism adapted to facilitate steerage of the main wheel;
a lock mechanism adapted to selectively limit steerage of the main wheel.

7. The apparatus according to claim 1 further comprising:
a steering mechanism positioned between the main wheel and the chassis, the steering mechanism adapted to facilitate steerage of the main wheel;
a lock mechanism adapted to selectively limit steerage of the main wheel to a predetermined orientation.

8. The apparatus according to claim 1 further comprising a handle selectively attachable to the apparatus and adapted to facilitate selective steerage of the main wheel.

9. An apparatus for use with a shipping container, comprising:
a substantially rigid chassis;
a connecting mechanism adapted to selectively connect a bottom corner of the container to the chassis;
a wheel adapted to support the chassis on a surface;
an elevating mechanism adapted to provide selective adjustment in elevation of the wheel relative to the chassis.

10. The apparatus according to claim 9 wherein the elevating mechanism is adapted to position the connecting mechanism substantially below the surface.

11. An apparatus for use with a shipping container, comprising:
a substantially rigid chassis;
a connector supported by the chassis and adapted to connectively engage a bottom corner of the container;
an elevator attached to the chassis;
a wheel operatively attached to the elevator, wherein the elevator is adapted to provide selective adjustment in elevation of the wheel relative to the chassis.
